(19) United States
(12) Patent Application Publication
(10) Pub. No.: US 2006/0088299 A1
(43) Pub. Date: Apr. 27, 2006

(54) Peer-to-peer-type content distribution system and content reproduction terminal device for use therein

(76) Inventor: Yasushi Ikeda, Neyagawa-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/234,043

(22) Filed: Sep. 23, 2005

(30) Foreign Application Priority Data
Oct. 25, 2004 (JP) 2004-309523

(51) Int. Cl. H04N 5/781

(52) U.S. Cl. 386/125

(57) ABSTRACT

If a peer 20 fails in an event notification (NO in S214), the peer 20 immediately stops the reproduction of a content item even when the content item is being reproduced (S221), and prohibits the reproduction of the content item (S222). After a retry interval time elapses since the prohibition of content reproduction (YES in S223), the event notification operation resumes (S213). If the event notification then succeeds (YES in S214), the prohibition of content reproduction is removed (S227). When a network failure occurs, content reproduction is not prohibited immediately after the occurrence of the network failure, but it is rather prohibited after a predetermined grace period elapses since the failure time (YES in S218).

### BACKGROUND OF THE INVENTION

1. Field of the Invention

The present invention relates to a peer-to-peer-type content distribution system and a content reproduction terminal device (peer) for use therein, and more particularly to a hybrid-type content distribution system using a center server and content reproduction terminal device for use therein.

2. Description of the Related Art

In a conventional client-server-type content distribution system, content items are stored in the server and are sent to clients as requested by the clients. With this system, however, it is necessary to upgrade the server as the number of clients increases, and the management and maintenance costs will inevitably increase.

In a peer-to-peer-type content distribution system, which has been popular in recent years, content items are exchanged between peers, and the file transfer loads are distributed among different peers. Therefore, with this system, content items can be distributed among a much larger number of peers (clients) as compared with the client-server-type content distribution system.

However, with the peer-to-peer-type content distribution systems currently available, it is difficult to keep track of, and control, how content items are exchanged and used, and therefore users of these systems may infringe the copyrights of content items being exchanged. “Gnutella” and “Winny” are known content distribution systems of a pure peer-to-peer type using no center server, and they have both raised serious copyright issues.

“Napster” is a known content distribution system of a peer-to-peer type using a center server. A system of this type is also called a “hybrid-type content distribution system” because it is a mix of a peer-to-peer system and a client-server system.

In a hybrid-type content distribution system, in order to keep track of, and control, how content items are exchanged and used, each peer provides the center server with real-time notification of its own operation status, and the center server bills the user of each peer based on the content usage history of that peer, which is compiled based on the real-time notification of the peer's operation status.

A hybrid-type content distribution system is typically a download-type system in which a content item is reproduced after it is completely downloaded, as opposed to a streaming-type system in which a content item is reproduced while being downloaded. In a streaming-type system, when a network failure occurs, the transfer of a content item stops and the reproduction of the content item also stops. In a download-type system, even when a network failure occurs, the reproduction of a content item does not stop as long as the content item has already been downloaded completely.

In a hybrid-type content distribution system being a download-type system, if a network failure occurs, a peer can no longer notify the center server of the peer's operation status, whereby the center server can no longer bill for the peer according to the content usage by the peer. An unauthorized use of a content item may become possible not only when a network failure occurs in an upstream place, e.g., at an ISP (Internet Service Provider) or an IX (Internet exchange), but also when a malicious user prevents a peer from notifying the center server of the peer's operation status by, for example, disconnecting a network cable.

### SUMMARY OF THE INVENTION

It is therefore an object of the present invention to provide a peer-to-peer-type content distribution system capable of preventing an unauthorized use of a content item, and a content reproduction terminal device for use therein. Another object of the present invention is to provide a peer-to-peer-type content distribution system in which the user is allowed to reproduce a content item when a network failure occurs due to a cause other than a user's fault, and a content reproduction terminal device for use therein.

A peer-to-peer-type content distribution system of the present invention includes a center server, and a plurality of peers connected to the center server. The center server includes: a peer operation status storage section for storing an operation status of the peers; and a section for registering the operation status sent from the peers in the peer operation status storage section. Each peer includes: a content storage section for storing a content item; a section for downloading a desired content item from another peer and storing the desired content item in the content storage section; a content reproduction section for reading out a content item from the content storage section and reproducing the content item; an operation status sending section for sending an operation status of the peer to the center server; and a reproduction disabling section for disabling reproduction of a content item by the content reproduction section if the sending of the operation status fails.

In this system, each peer sends an operation status of the peer to the center server, and if the sending of the operation status fails, the reproduction of the content item by the content reproduction section is disabled. Therefore, if any network failure occurs, the peer can no longer reproduce the content item. Thus, it is possible to prevent an unauthorized use of a content item.

A content reproduction terminal device of the present invention includes: a content storage section for storing a content item; a section for downloading a desired content item and storing the desired content item in the content storage section; a content reproduction section for reading out a content item from the content storage section and reproducing the content item; an operation status sending section for sending an operation status of the content reproduction terminal device to a center server; and a reproduction disabling section for disabling reproduction of a content item by the content reproduction section if the sending of the operation status fails.

This device sends the operation status of the device to the center server, and if the sending of the operation status fails, the reproduction of the content item by the content reproduction section is disabled. Therefore, if any network failure occurs, the device can no longer reproduce the content item. Thus, it is possible to prevent an unauthorized use of a content item.

Preferably, the operation status sending section periodically sends an alive event as the operation status. The time intervals at which alive events are sent do not have to be constant but may vary.

In such a case, even if none of events (e.g., POWER ON, POWER OFF, DOWNLOAD STARTED, DOWNLOAD COMPLETED, REPRODUCTION STARTED, or REPRODUCTION STOPPED) occurs for a predetermined amount of time or longer, an alive event is periodically sent, whereby it is possible to reliably detect a network failure.

Preferably, the reproduction disabling section includes: a section for determining whether or not the content reproduction section is reproducing a content item; and a section for stopping the reproduction of the content item by the content reproduction section if it is determined that the content reproduction section is reproducing the content item.

In such a case, if the sending of an operation status fails, a content item is immediately prevented from being reproduced even when the content item is being reproduced. Thus, it is possible to more completely prevent an unauthorized use of a content item.

Preferably, the content reproduction terminal device further includes: a section for resuming the sending of the operation status after a predetermined retry interval time elapses since when reproduction of a content item is disabled by the reproduction disabling section; and a reproduction enabling section for enabling reproduction of a content item by the content reproduction section if the sending of the operation status succeeds.

In such a case, even if content reproduction is disabled, the sending of the operation status resumes after a retry interval time elapses. If the sending of the operation status then succeeds, the content reproduction is enabled. Thus, the user can use, or resume the use of, the content item if the network failure is recovered.

Preferably, the reproduction disabling section includes: a section for recording a failure time at which the sending of the operation status failed; and a section for disabling reproduction of a content item by the content reproduction section after a predetermined grace period elapses since the recorded failure time.

In such a case, when a network failure occurs, content reproduction is not disabled immediately after the occurrence of the network failure, but it is rather disabled after a predetermined grace period elapses since the failure time. Thus, when a network failure occurs due to a cause other than a user's fault, the user is allowed to reproduce a content item until a predetermined grace period elapses.

More preferably, the content reproduction terminal device further includes: a section for resuming the sending of the operation status after a predetermined retry interval time elapses since when reproduction of a content item is disabled by the reproduction disabling section; and a reproduction enabling section for enabling reproduction of a content item by the content reproduction section if the sending of the operation status succeeds. The reproduction disabling section further includes a section for logging the operation status which failed to be sent. The reproduction enabling section further includes a section for sending the logged operation status to the center server when the sending of the operation status succeeds.

In such a case, operation statuses which fail to be sent are logged during the grace period, and are sent to the center server after the network failure is recovered. Therefore, it is possible to prevent an unauthorized use of a content item during the grace period.

A program for a content reproduction terminal of the present invention instructs a computer to function as various sections as set forth above.

### BRIEF DESCRIPTION OF THE DRAWINGS

FIG. 1 is a functional block diagram showing a configuration of a peer-to-peer-type content distribution system according to an embodiment of the present invention.

FIG. 2 shows the data structure of a record in a peer operation status database shown in FIG. 1.

FIG. 3 is a flow chart showing an event queuing operation by a peer shown in FIG. 1.

FIG. 4 is a flow chart showing a content reproduction enabling/disabling operation by a peer shown in FIG. 1.

FIG. 5 is a flow chart showing an operation of a center server corresponding to the operation of a peer shown in FIG. 4.

### DETAILED DESCRIPTION OF THE PREFERRED EMBODIMENTS

A preferred embodiment of the present invention will now be described with reference to the drawings. Like elements are denoted by like reference numerals throughout the various figures, and will not be described repeatedly.

1. Configuration

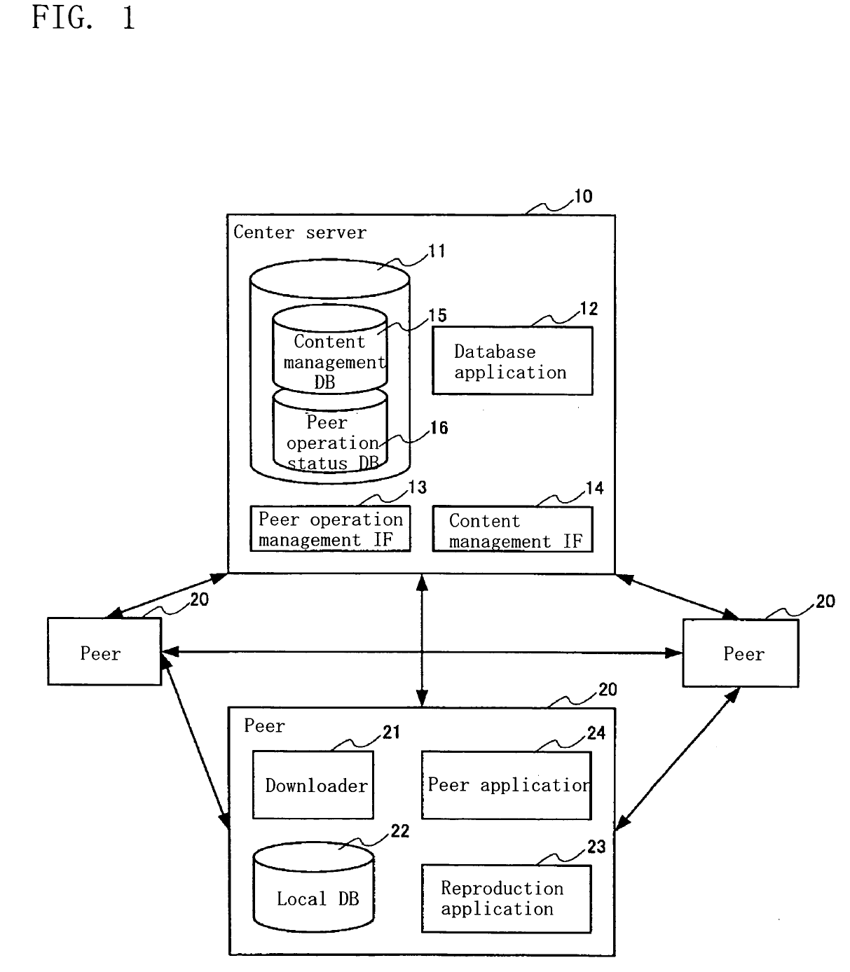

Referring to FIG. 1, a peer-to-peer-type content distribution system according to an embodiment of the present invention includes a center server 10, and a large number of peers (content reproduction terminal devices) 20. The peers 20 are connected to the center server 10 via a telecommunications line (not shown) such as the Internet, and can also be connected to one another. Content items are distributed among the peers 20 by being exchanged between the peers 20. Therefore, content items are stored in the peers 20 and not in the center server 10.

The center server 10 controls the distribution of content items among the peers 20 by collecting information regarding the particulars and the locations of content items stored in the peers 20 (hereinafter referred to as “content information”) and by sending the collected content information to the peers 20.

Each peer 20 sends the center server 10 the content information regarding content items stored therein, and receives from the center server 10 the content information regarding a desired content item. Therefore, each peer 20 functions also as a client with respect to the center server 10. Based on the content information obtained from the center server 10, each peer 20 downloads a desired content item from another peer 20.

For example, the center server 10 may be commonly operated by a plurality of content providers. Each peer 20 may be operated by a user who purchases content items. Specifically, each peer 20 may be a user's personal computer, which has a 24-hour Internet connection via a high-speed broadband service such as FTTH (Fiber To The Home), ADSL (Asymmetric Digital Subscriber Line) and CATV (Cable TV).

A specific configuration of the system will now be described.

1. 1. Center Server

The center server 10 includes a global database 11, a database application 12, a peer operation management interface 13, and a content management interface 14.

The global database 11 includes a content management database 15 and a peer operation status database 16. The content management database 15 stores content information regarding content items stored in the peers 20. The peer operation status database 16 stores the operation status of each peer 20.

The peer operation management interface 13 receives operation status information from each peer 20 (hereinafter referred to as the “peer operation status”).

The content management interface 14 receives content information from the peers 20. The content management interface 14 also receives a query issued from a peer 20, and sends a content list produced according to the query to the peer 20.

The database application 12 registers the peer operation status received by the peer operation management interface 13 in the peer operation status database 16. The database application 12 registers the content information received by the content management interface 14 in the content management database 15. The database application 12 performs a search through the content management database 15 according to the query received by the content management interface 14, and produces a content list including the retrieved content information.

1. 2. Peer

The peer 20 includes a downloader 21, a local database 22, a reproduction application 23, and a peer application 24.

The downloader 21 downloads desired content items from other peers 20, and stores them in the local database 22. The reproduction application 23 reads out a desired content item from the local database 22 by a streaming method, and reproduces sound and/or video images based on the content item.

The peer application 24 issues a query requesting the center server 10 to send the content information for a desired content item, and registers the content information for the desired content item in the local database 22 based on the content list obtained from the center server 10. The peer application 24 specifies one or more peers 20 storing the desired content item based on the obtained content information. The peer application 24 requests the desired content item from the specified peer, and starts the downloader 21 for downloading the desired content item. The peer application 24 sends the content information for the registered content item and the operation status of the peer 20 to the center server 10. The peer application 24 can also send a desired content item in response to a request from another peer 20.

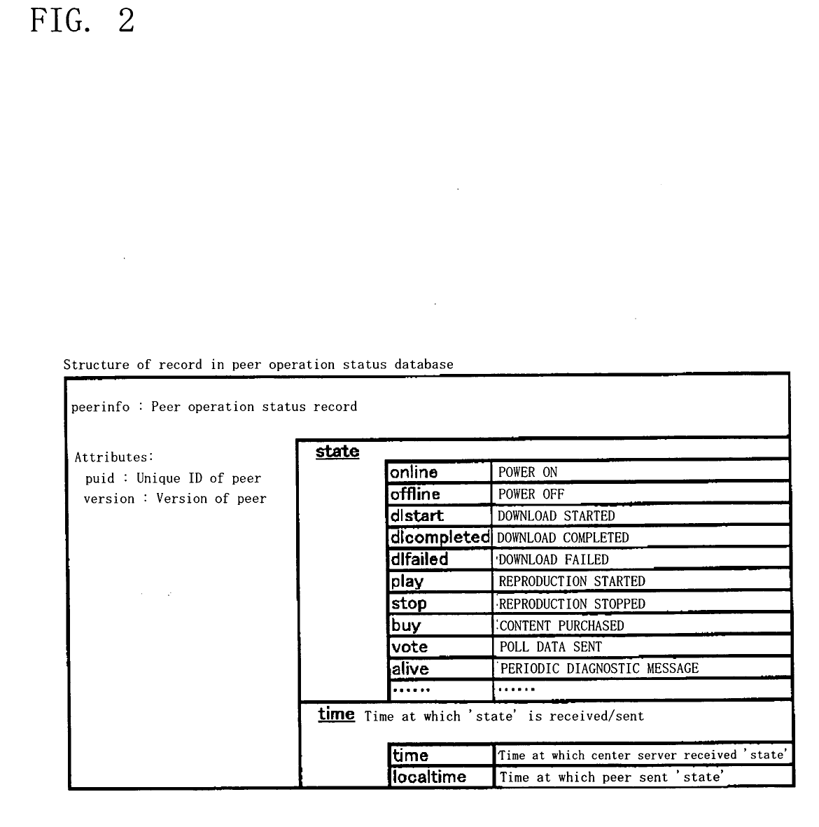

FIG. 2 shows the data structure of a record in the peer operation status database 16. The peer operation status database 16 includes a number of peer operation status records (‘peerinfo’), and the number of peer operation status records is equal to the total number of the peers 20. Each peer operation status record (‘peerinfo’) includes the peer operation status (“state”) representing the operation status of the peer, and the time of sending/receiving (“time”) of the peer operation status (“state”). The attributes of the peer operation status record (‘peerinfo’) include the unique ID (‘puid’) of the peer and the version (‘version’) of the peer.

The peer operation status (‘state’) includes various events of the peer such as POWER ON (‘online’), POWER OFF (‘offline’), DOWNLOAD STARTED (‘dlstart’), DOWNLOAD COMPLETED (‘dlcompleted’), REPRODUCTION STARTED (‘play’), REPRODUCTION STOPPED (‘stop’), CONTENT PURCHASED (‘buy’), POLL DATA SENT (‘vote’), and a PERIODIC DIAGNOSTIC MESSAGE (hereinafter referred to as an “alive event”) (‘alive’). These events are generally classified into user events and system events. A user event occurs in response to an action of the user, and includes REPRODUCTION STARTED (‘play’), REPRODUCTION STOPPED (‘stop’), CONTENT PURCHASED (‘buy’), POLL DATA SENT (‘vote’), etc. A system event is caused by the peer 20 to occur in the background, and includes POWER ON (‘online’), POWER OFF (‘offline’), DOWNLOAD STARTED (‘dlstart’), DOWNLOAD COMPLETED (‘dlcompleted’), alive event (‘alive’), etc.

The time of sending/receiving (‘time’) includes the time (‘time’) at which the center server 10 receives the peer operation status (‘state’), the time (‘localtime’) at which the peer 20 sends the peer operation status (‘state’), etc. If the internal clock of the center server 10 and that of the peer 20 have the same time, the time (‘time’) and the time (‘localtime’) will also be the same.

2. Operation

The operation of the system will now be described.

2. 1. Event Queuing By Peer

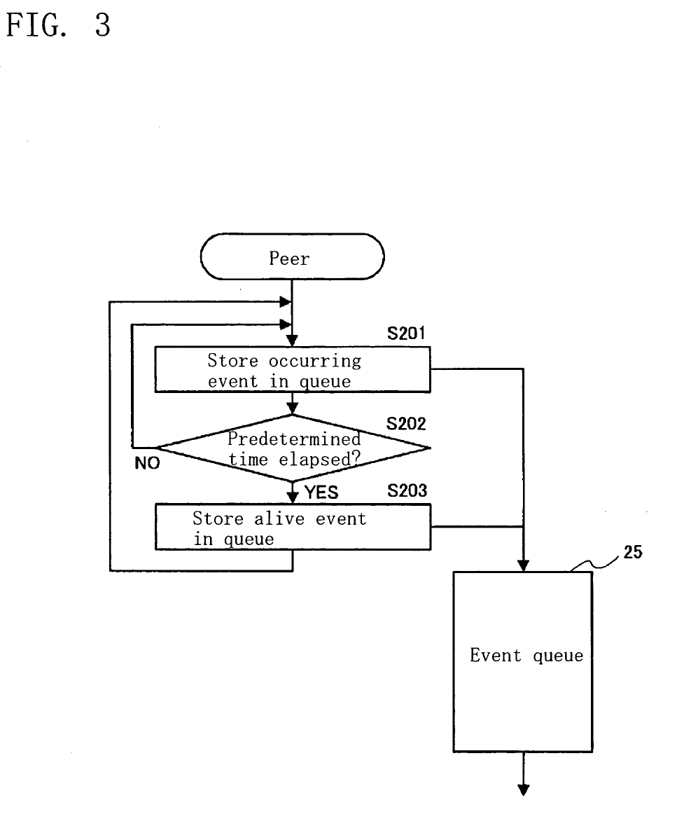

First, an operation of the peer 20 for storing an event in a queue will be described with reference to FIG. 3.

In each peer 20, the peer application 24 causes various events according to the operation status of the peer 20, e.g., POWER ON (‘online’), POWER OFF (‘offline’), DOWNLOAD STARTED (‘dlstart’), DOWNLOAD COMPLETED (‘dlcompleted’), REPRODUCTION STARTED (‘play’), REPRODUCTION STOPPED (‘stop’), CONTENT PURCHASED (‘buy’), and POLL DATA SENT (‘vote’).

The peer application 24 stores an occurring event in an event queue 25 (S201). The event queue 25 is a queue implemented on a hard disk drive (not shown) or a memory (not shown) of the peer 20.

The peer application 24 successively stores events that occur successively in the event queue 25 (S201) until a predetermined amount of time elapses (while NO is returned in S202).

When the predetermined amount of time elapses (YES in S202), the peer application 24 stores an alive event (‘alive’) in the event queue 25 (S203), and returns to step S201. Therefore, even if no event occurs for the predetermined amount of time, at least one alive event (‘alive’) is stored in the event queue 25.

2. 2. Reproduction Enabling/Disabling Operation By Peer

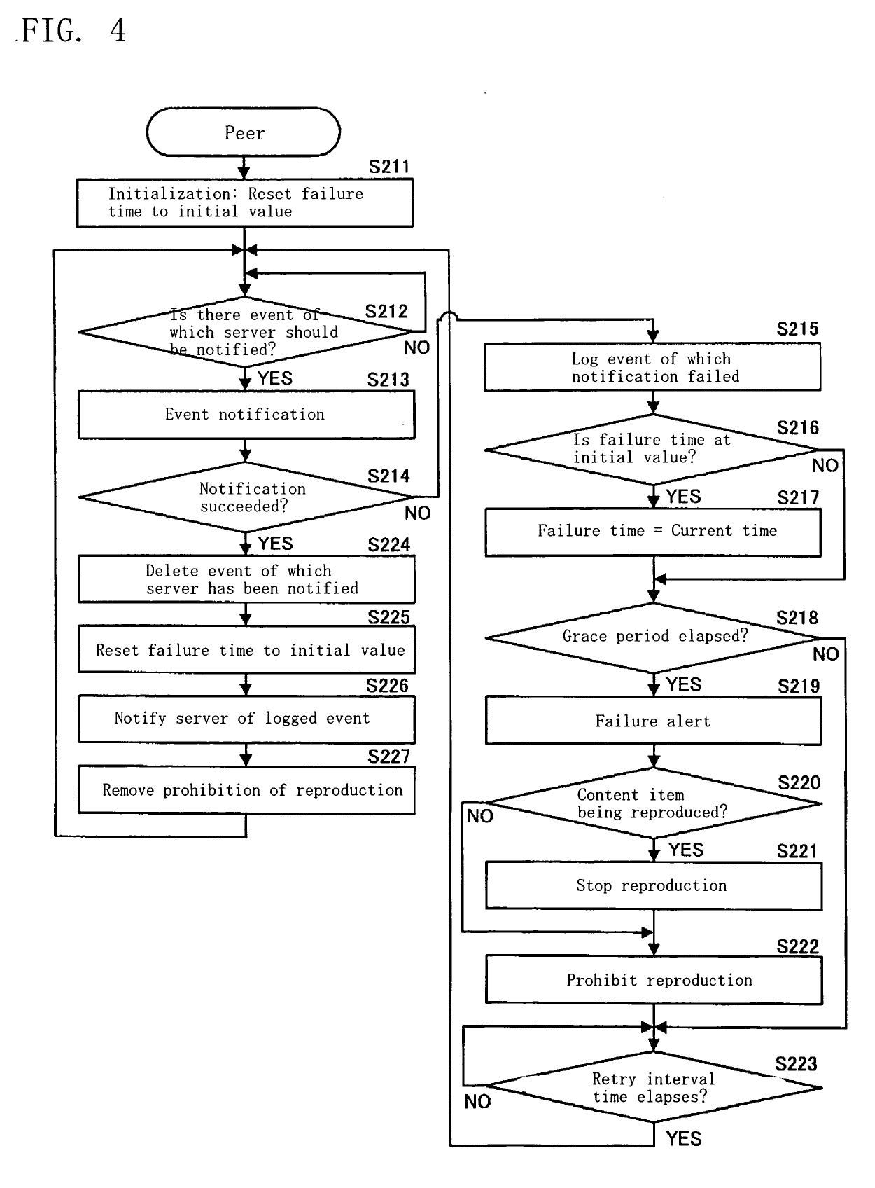

Next, an operation of the peer 20 for enabling/disabling the reproduction of a content item will be described with reference to FIG. 4.

In each peer 20, the peer application 24 performs an initialization operation, and resets the failure time to the initial value (=0) (S211).

The peer application 24 refers to the event queue 25 to determine whether or not there is any event that the center server 10 should be notified of, i.e., whether or not the event queue 25 is empty (S212). If there is any such event, i.e., if the event queue 25 is not empty (YES in S212), the peer application 24 notifies the center server 10 of one or more events stored in the event queue 25 in the form of the peer operation status (S213).

The peer application 24 disables the reproduction of a content item by the reproduction application 23 (S215 to S222) if the event notification fails (NO in S214), and enables the reproduction of a content item by the reproduction application 23 (S224 to S227) if the event notification succeeds (YES in S214). For example, the determination as to whether an event notification has succeeded/failed can be done as follows. The center server receiving an event notification from a peer returns an acknowledgement notification to the peer, which determines the presence/absence of such an acknowledgement notification from the center server. An operation in a case where an event notification fails will now be described, and then an operation in a case where an event notification succeeds will now be described.

If an event notification fails (NO in S214), the peer application 24 first logs the event of which the notification has failed (S215). Then, if the failure time is still at the initial value (YES in S216), the peer application 24 records the failure time by setting it to the current time. If the failure time is not at the initial value (NO in S216), the peer application 24 skips step S217 so that the failure time remains as it is.

Then, the peer application 24 determines whether or not a predetermined grace period has elapsed since the recorded failure time, i.e., whether or not the relationship “(current time-failure time)>grace period” holds true (S218).

If the grace period has elapsed since the failure time (YES in S218), the peer application 24 disables the reproduction of a content item by the reproduction application 23 (S219 to S222). If the grace period has not elapsed (NO in S218), the peer application 24 skips steps S219 to S222 so as not to disable the reproduction of a content item.

If the grace period has elapsed since the failure time (YES in S218), the peer application 24 notifies the user of the failure (S219) by, for example, displaying a message on the screen indicating that the peer is disconnected from the center server.

Then, the peer application 24 determines whether or not the reproduction application 23 is reproducing the content item (S220). If so (YES in S220), the peer application 24 stops the reproduction of the content item by the reproduction application 23 (S221). Otherwise (NO in S220), the peer application 24 skips step S221.

Then, the peer application 24 prohibits access to, and thus the reproduction of, the content item by, for example, invalidating remote controller operations (S222).

After a predetermined retry interval time elapses since the disablement of the reproduction of a content item as described above, the peer application 24 returns to step S212 to resume the event notification operation of step S213 (S223).

If an event notification succeeds (YES in S214), the peer application 24 deletes the notified event from the event queue 25 (S224), and resets the failure time to the initial value (S225).

Then, the peer application 24 notifies the center server 10 of the event or events logged in step S215, i.e., the event or events of which the notification has failed (S226). Thus, the center server 10 can also collect all the events occurring in the peer 20 during the grace period.

Then, the peer application 24 removes the prohibition of access to the content item, and thus enables the reproduction of the content item, by, for example, validating remote controller operations (S227).

2. 3. Monitoring Peer Connection By Center Server

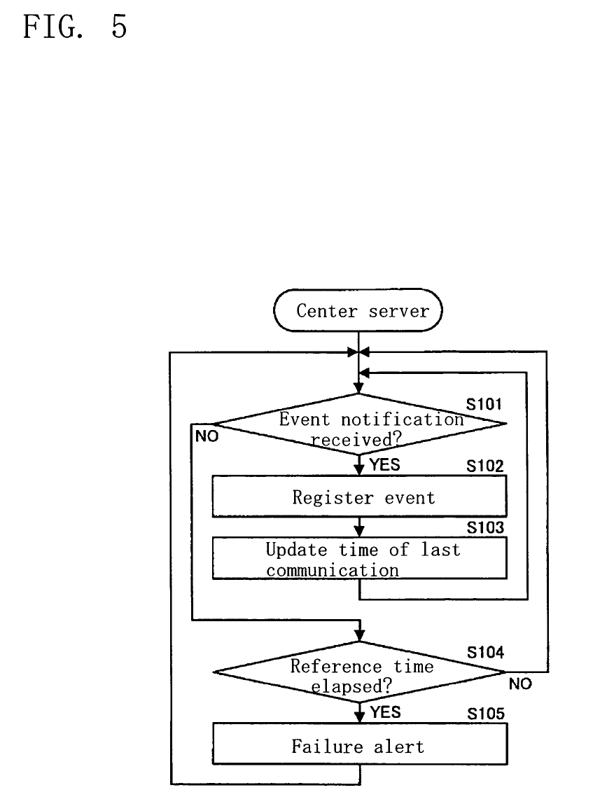

Next, an operation of the center server 10 for monitoring the connection of a peer will be described with reference to FIG. 5.

In the center server 10, when the database application 12 receives an event notification from the peer 20 (YES in S101), the database application 12 registers the event in the peer operation status database 16 (S102), and records the time (‘time’) at which the center server 10 received the event as the time of receiving/sending (‘time’) of the peer operation status (‘state’), thus updating the time of last communication with the peer 20 (S103).

If a predetermined reference time (e.g., 15 minutes) elapses since the time of last communication while there is no event notification from the peer 20 (NO in S101), i.e., if the relationship “(current time—time of last communication)>reference time” holds true (YES in S104), the database application 12 notifies the administrator of the center server 10 of the failure by, for example, displaying a message on the screen indicating that the peer is disconnected (S105). In response to this, the administrator may take an appropriate course of action, e.g., telephone, or send email to, the user of the peer.

As described above, according to the embodiment of the present invention, each peer 20 notifies the center server 10 of an event, and if the event notification fails (NO in S214), the reproduction of the content item is prohibited (S222). Therefore, if any network failure occurs, the peer 20 can no longer reproduce the content item. Thus, it is possible to prevent an unauthorized use of a content item.

Even if no event occurs for a predetermined amount of time or longer, an alive event is periodically stored in the event queue 25 and thus the center server 10 is notified of the alive event periodically, whereby it is possible to reliably detect a network failure.

If an event notification fails (S213), the reproduction of a content item is stopped (S221) even when the content item is being reproduced (YES in S220), whereby it is possible to completely prevent an unauthorized use of a content item.

After a retry interval time elapses since the prohibition of content reproduction (YES in S223), the event notification operation resumes (S213). If the event notification then succeeds, the prohibition of content reproduction is removed (S227). Therefore, the user can use, or resume the use of, the content item if the network failure is recovered.

The reproduction of a content item is not prohibited immediately after the occurrence of a network failure, but it is rather prohibited after a predetermined grace period elapses since the failure time (YES in S218) (S222). Therefore, even if a network failure occurs in an upstream place, e.g., at an internet service provider, the content item can be reproduced until the predetermined grace period elapses. Moreover, during the grace period, any event of which the notification fails is logged (S215), and the center server 10 is notified of such events (S226) after the network failure is recovered. Therefore, it is possible to prevent an unauthorized use of a content item during the grace period.

While a content item is sent from a peer to a requesting peer in response to a request from the requesting peer in the embodiment described above, a content item may be sent automatically from the sender peer to the requesting peer in response to an instruction from the center server, etc. The content information may also be sent automatically from the center server to the peer.

While the present invention has been described above in a preferred embodiment, it is understood that the embodiment is merely illustrative of how the invention may be carried out, and it is apparent to those skilled in the art that variations and modifications thereof can be made without departing from the spirit and scope of the invention.

The peer-to-peer-type content distribution system of the present invention is applicable to content distribution services using the Internet.

What is claimed is:

1. A peer-to-peer-type content distribution system, comprising a center server, and a plurality of peers connected to the center server, the center server including:
a peer operation status storage section for storing an operation status of the peers; and
a section for registering the operation status sent from the peers in the peer operation status storage section, each peer including:
a content storage section for storing a content item;
a section for downloading a desired content item from another peer and storing the desired content item in the content storage section;
a content reproduction section for reading out a content item from the content storage section and reproducing the content item;
an operation status sending section for sending an operation status of the peer to the center server; and
a reproduction disabling section for disabling reproduction of a content item by the content reproduction section if the sending of the operation status fails.

2. A content reproduction terminal device, comprising:
a content storage section for storing a content item;
a section for downloading a desired content item and storing the desired content item in the content storage section;
a content reproduction section for reading out a content item from the content storage section and reproducing the content item;
an operation status sending section for sending an operation status of the content reproduction terminal device to a center server; and
a reproduction disabling section for disabling reproduction of a content item by the content reproduction section if the sending of the operation status fails.

3. The content reproduction terminal device according to claim 2, wherein the operation status sending section periodically sends an alive event as the operation status.

4. The content reproduction terminal device according to claim 2, wherein the reproduction disabling section includes:
a section for determining whether or not the content reproduction section is reproducing a content item; and
a section for stopping the reproduction of the content item by the content reproduction section if it is determined that the content reproduction section is reproducing the content item.

5. The content reproduction terminal device according to claim 2, further comprising:
a section for resuming the sending of the operation status after a predetermined retry interval time elapses since when reproduction of a content item is disabled by the reproduction disabling section; and
a reproduction enabling section for enabling reproduction of a content item by the content reproduction section if the sending of the operation status succeeds.

6. The content reproduction terminal device according to claim 2, wherein the reproduction disabling section includes:
a section for recording a failure time at which the sending of the operation status failed; and
a section for disabling reproduction of a content item by the content reproduction section after a predetermined grace period elapses since the recorded failure time.

7. The content reproduction terminal device according to claim 6, further comprising:
a section for resuming the sending of the operation status after a predetermined retry interval time elapses since when reproduction of a content item is disabled by the reproduction disabling section; and
a reproduction enabling section for enabling reproduction of a content item by the content reproduction section if the sending of the operation status succeeds, wherein:
the reproduction disabling section further includes a section for logging the operation status which failed to be sent; and
the reproduction enabling section further includes a section for sending the logged operation status to the center server when the sending of the operation status succeeds.

8. A program for a content reproduction terminal, instructing a computer to perform:
a step of downloading a desired content item and storing the desired content item in a content storage section;
a step of reading out a content item from the content storage section and reproducing the content item;
an operation status sending step of sending an operation status of the content reproduction terminal to a center server; and
a reproduction disabling step of disabling reproduction of a content item if the sending of the operation status fails.

9. The program for a content reproduction terminal according to claim 8, wherein an alive event is periodically sent as the operation status in the operation status sending step.

10. The program for a content reproduction terminal according to claim 8, wherein the reproduction disabling step includes:
a step of determining whether or not a content item is being reproduced;
a step of stopping the reproduction of the content item if it is determined that the content item is being reproduced.

11. The program for a content reproduction terminal according to claim 8, further instructing a computer to perform:
a step of resuming the sending of the operation status after a predetermined retry interval time elapses since when reproduction of a content item is disabled in the reproduction disabling step; and
a reproduction enabling step of enabling reproduction of a content item if the sending of the operation status succeeds.

12. The program for a content reproduction terminal according to claim 8, wherein the reproduction disabling step includes:
a step of recording a failure time at which the sending of the operation status failed; and
a step of disabling reproduction of a content item after a predetermined grace period elapses since the recorded failure time.

13. The program for a content reproduction terminal according to claim 12, further instructing a computer to perform:
a step of resuming the sending of the operation status after a predetermined retry interval time elapses since when reproduction of a content item is disabled in the reproduction disabling step; and
a reproduction enabling step of enabling reproduction of a content item if the sending of the operation status succeeds, wherein:
the reproduction disabling step further includes a step of logging the operation status which failed to be sent; and
the reproduction enabling step further includes a step of sending the logged operation status to the center server when the sending of the operation status succeeds.
